(19) United States
(12) Patent Application Publication
(10) Pub. No.: US 2018/0361678 A1
(43) Pub. Date: Dec. 20, 2018

(54) APPARATUS AND METHODS OF USE FOR FORM, FILL AND SEALING DIES AND PACKAGES FORMED THEREBY

(71) Applicant: SABIC GLOBAL TECHNOLOGIES B.V., Bergen op Zoom (NL)

(72) Inventors: Tariq SYED, Riyadh (SA); Bart Albertus Hubertus ESSCHERT VAN DEN, Geleen (NL)

(73) Assignee: SABIC Global Technologies B.V., Bergen op Zoom (NL)

(21) Appl. No.: 16/060,127

(22) PCT Filed: Nov. 21, 2016
(86) PCT No.: PCT/IB2016/056995

§ 371 Date: Jun. 7, 2018

Related U.S. Application Data
(60) Provisional application No. 62/264,452, filed on Dec. 8, 2015.

(51) Int. Cl. B29C 65/00; B29C 65/18; B65B 51/30; B65B 51/32

(52) U.S. Cl. CPC B29C 66/349; B29C 65/18; B29C 66/0342; B29C 66/4312; B29L 2031/712; B29C 66/849; B65B 51/30; B65B 51/32; B29C 66/4322

(57) ABSTRACT

Provided herein are apparatus and methods for film sealing dies, and in particular, to apparatus and methods for film sealing dies in form, fill and seal (FFS) processes. An apparatus for sealing plastic film materials includes a heating mechanism, the heating mechanism including a heating lip (110) arranged such that when a plastic film (120) is contacted with the heating lip (110), the heating lip (110) forms a hot seal on the plastic film (120); and a cooling mechanism, the cooling mechanism comprising a gas jet duct oriented to contact the hot seal on the plastic film (120) at a contact angle between 0 and 60° such that the hot seal formed on the plastic film (120) is cooled to a temperature of less than or equal to 40° C. in less than or equal to 5 seconds to form a sealed plastic film.

### TECHNICAL FIELD

This disclosure relates to apparatus and methods for film sealing dies, and in particular, to apparatus and methods for film sealing dies in form, fill, and seal (FFS) processes.

### BACKGROUND

Form, fill, and seal (FFS) processes, and more specifically vertical form, fill, and seal (VFFS) processes, have been used to package various foods, beverages and other products.

Such processes often include the use of a roll of film being fed to a forming tube. As the center of the film approaches the forming tube, the edges of the film wrap around the tube and the film are pulled downward such that a vertical seam can be created on the edges of the film by a vertical heat sealing bar. The vertical seam, which often forms the back seal of a package, is thus the bonded edges of the film as a result of melting the plastic edges together, thereby creating a tube formed from the plastic.

The packaging or bagging process then includes a horizontal bar or bars that seal the bottom edge of the tube in order that filling of the package can occur. The sealing bar or bars then seal the package to create a top seal after the bag is filled and remaining film can be cut off or removed.

Such processes have often resulted in packages having top seals, bottom seals or both top and bottom seals that have inadequate seal strength, contain wrinkles, tear easily or can otherwise be lacking in aesthetic appearance or exhibit undesirable visual appeal.

There accordingly remains a need in the art for improved apparatus and methods suitable for form, fill, and seal processes.

### BRIEF DESCRIPTION

Provided herein are apparatus and methods for form, fill, and seal (FFS) processes as well as packages formed thereby.

In an aspect, an apparatus for sealing plastic film materials includes a heating mechanism, the heating mechanism comprising a heating lip arranged such that when a plastic film is contacted with the heating lip, the heating lip forms a hot seal on the plastic film; and a cooling mechanism, the cooling mechanism comprising a gas jet duct oriented to enable a gas jet to contact the hot seal on the plastic film at a contact angle of between 0-60° such that the hot seal formed on the plastic film is cooled in less than or equal to 5 seconds down to a temperature of less than or equal to 40° C., to form a sealed plastic film.

In other aspects, a method of forming a seal on a plastic film includes: introducing a plastic film to an apparatus including a die, the apparatus including a heating mechanism including a heating lip and a cooling mechanism including a gas jet duct; and forming a hot seal on the plastic film with the sealing lip; withdrawing the sealing lip from the plastic film; and cooling the hot seal with a gas jet to form the sealed plastic film, wherein the hot seal is cooled to a temperature of less than or equal to 40° C. in less than or equal to 5 seconds.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 illustrates a flow diagram suitable for use in a form, fill, and seal in accordance herein.

FIG. 2 illustrates a front view of a die suitable for use in accordance herein.

FIG. 3 shows a side view of a die suitable for use in accordance herein.

FIG. 4 illustrates a side view of a die suitable for use in accordance with another aspect herein.

### DETAILED DESCRIPTION

Accordingly, provided herein are apparatus and methods for forming packages. In some aspects, the methods used include form, fill, and seal processes (FFS) and more specifically, vertical form, fill, and seal (VFFS) processes. The apparatus and methods allow for improved sealing characteristics as well as improved aesthetic characteristics (e.g., less wrinkling or crinkling of the formed package). Packages that can be formed in accordance with the apparatus and methods provided herein can include one or more of the foregoing: food storage packages, liquid (e.g., beverage) storage packages, cosmetic storage packages, soap storage packages, pharmaceutical packages.

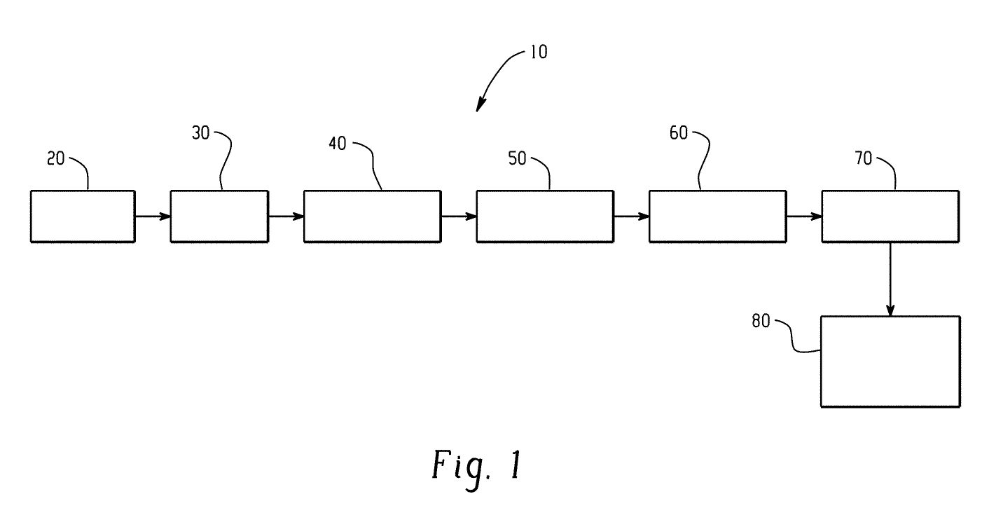

Referring now to FIG. 1, a flow diagram for a packaging process is illustrated. Such a process can include for example vertical form, fill, and seal (VFFS) processes. Process 10 includes providing film 20 (such as film 120 or film 133 as discussed herein) to forming tube 30 such that film 20 winds around forming tube 30 and can in a VFFS process, be pulled downward, thereby forming a tube. Formation of back seal step 40 can include a vertical heat sealing bar or mechanism that seals the edges of film 20 wrapped around forming tube 30. The formed tube can then be pulled downward and a heat sealing die as discussed herein can be used for formation of bottom seal 50, thereby forming an open package. Filling of package 60 includes filling the package with the desired food, liquid or other product, followed by formation of top seal 70 and subsequent processing and completed packaging 80. Process 10 can be a batch or continuous process.

It will be appreciated that use of the films and processes provided herein are not limited to VFFS. As mentioned above, alternative apparatus and processes can be employed such that horizontal form, fill, and seal (HFFS) processes or dual web packaging can be used in conjunction with the plastic films.

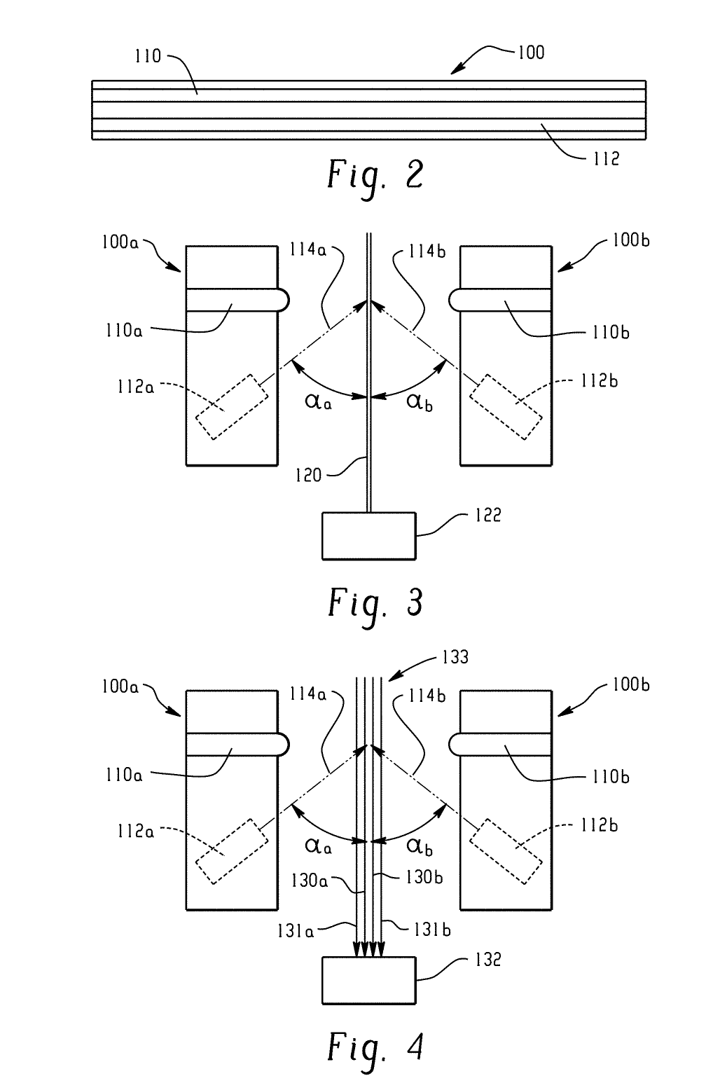

Reference is now had to FIG. 2 which illustrates a front view of die sealing bar 100. Die apparatus 100 includes a heating mechanism that includes heat sealing lip 110 and a cooling mechanism that includes gas duct 112 arranged to provide gas cooling (e.g. gas jet, 114a, 114b, or 114a and 114b shown for example in FIGS. 3 and 4) to a film 120 or 133 immediately following heat sealing by heat sealing lip 110. Heat sealing lip 110 can be of the type that is currently commercially available. The gas of the gas jets can be inert gases (e.g., a gas which does not undergo chemical reactions under a set of given conditions). For example, the gas includes air (e.g., compressed air), nitrogen, helium, and combinations comprising the foregoing. In some arrangements, gas jets (e.g., air jets) can be used based on convenience and cost.

Film 120 can be formed of a conventional film material as is known in the art.

In some aspects, a single die 100 can be used in a process to form a plastic seal. In such a case, the die could be pressed against a surface with film 120 (or film 133 discussed herein) therebetween to create the desired hot seal and cooling. The angle of the gas jet (e.g., air jet) can be selected to contact a sufficient amount of the hot seal just formed to provide adequate cooling and sealing. In some aspects, the gas jet (e.g., air jet) will be arranged to contact the entire hot seal to be cooled. If the angle of the gas jets (e.g., air jet) is too low or too high, the gas jet (e.g., air jet) could miss contacting the desired hot seal or only contact a portion of the desired hot seal such that an inadequate seal or a seal otherwise lacking in aesthetic appeal is formed thereby.

As can be seen in more detail in FIG. 3, in operation, 100 can include for example two die halves, 100a and 100b, to be used to clamp or seal film 120 by closing the dies inwardly around film 120 within a temperature in the range of 40-350° C. (for example 40° C. to 160° C. or 200° C. to 300° C., depending upon the melting temperature of the film), depending upon the type of material used for the film. The temperature ranges that can be used in the process will depend on various factors such as the polymer used and other processing conditions. For example, the seal that is formed and the strength of the seal will in part depend on the thickness and composition of the film. The temperature is a heating temperature that will melt the composition of the film in less than or equal to 2 seconds while allowing the seal to be cooled to a temperature of less than or equal to 40° C. in less than or equal 5 seconds. For example, the process can be used to heat a plastic film to the melt temperature of the plastic film, such as in less than or equal to 2 seconds, for example, less than or equal to 1 second, or even less than or equal to 0.5 seconds; thereby forming the hot seal. This hot seal can then be cooled to less than or equal to 40° C. (for example, less than or equal to 30° C., e.g., 20° C. to 40° C.) in less than or equal to 5 seconds, for example, less than or equal to 4 second or less than or equal to 3 seconds, e.g., in 1 to 5 seconds or 1 to 3 seconds.

In some aspects, the heating mechanism is configured to provide the hot seal to the plastic film within a temperature range of 100-250° C. Hot sealing lips 110a and 110b thus contact film 120 to form the seal, e.g., a bottom seal of a package or a top seal of a package 122. In a continuous process, the formed seal can be a top seal of a filled package and a bottom seal of the next package in sequence. The packages can then be subsequently separated.

Following formation of the seal, the dies are retracted. As the dies are retracted, gas (e.g., air) ducts 112a and 112b are arranged to immediately (e.g. within a few milliseconds, i.e. almost instantaneously) provide gas jets (e.g., air jets) 114a and 114b arranged to contact the seal that has just been formed and cool the seal to a desired temperature. For example, cooling by the gas jet can be provided within less than or equal to 5 seconds; in some cases, less than or equal to 4 seconds; and in yet other instances, less than or equal to 3 seconds. In still other aspects, cooling by the gas jet can be provided within less than about 2 seconds; and in some cases, less than 1 second. Gas jet(s) (e.g., air jet) such as 114a, 114b, or 114a and 114b, are arranged to contact the formed seal on film 120 at an appropriate angle such as αₐ, α_{b} or αₐ and α_{b}. αₐ and α_{b} can be any angle arranged to provide desired cooling to the seal on film 120. αₐ, α_{b} or αₐ and α_{b} can be for example 0-60°. In other aspects, angle αₐ, α_{b}, or αₐ and ab can be 15-60°. The angle of the gas jet (e.g., air jet) can be selected to contact a sufficient amount of the just formed hot seal to provide cooling and sealing such that a cooled temperature of less than or equal to 40° C. is reached in less than or equal to 5 seconds. In some aspects, the gas jet (e.g., air jet) will be arranged to contact the entire hot seal to be cooled. If the angle of the gas jet (e.g., air jet) is too low or too high, the gas jet (e.g., air jet) could miss contacting the desired hot seal or only contact a portion of the desired hot seal such that an inadequate seal or a seal otherwise lacking in aesthetic appeal is formed thereby. The desired pressure and temperature can be determined based on the type of material to be sealed and/or the strength of the desired seal to be formed. In some aspects, the cooling mechanisms and gas (e.g., air) ducts 112a and 112b are arranged to respectively provide gas jets (e.g., air jets) 114a and 114b within a temperature range of less than 40° C. (e.g., less than 20° C., such as 0 to 40° C. or 0 to 20° C., or even 0 to 10° C.) such that the hot seal on the plastic film can be quenched within 1-5 seconds. In this manner, sealed packages 122 having improved sealing characteristics and aesthetic characteristics (e.g., less wrinkling or crinkling of the package) can be formed. In some aspects, packages 122 can be formed in a continuous manner.

The dies can be arranged such that as the hot sealing lip is retracted, the cooling mechanism is activated to provide the gas jet (e.g., air jet) and thus provide cooling at the seal. The hot sealing lips are therefore not cooled by the cooling mechanism as the initiation of the retraction of the hot sealing lips is arranged to initiate the cooling process. The seal time can vary depending on the conditions and set up of the seals to be formed and materials to be used. It is expected that the cooling mechanism will allow for a cooling time of at least 40% less than conventional cooling time, i.e., the cooling time using the cooling mechanisms herein can allow for hot seals formed of the same materials and conditions to be cooled to ambient in at least 40% less time than the time required to cool a hot seal simply using ambient conditions for cooling. Thus, the cooling mechanism provided herein allows for improved seals as well as a faster process. In some aspects, it is expected that the cooling mechanism will allow for a cooling time of at least 50% less than conventional cooling time, and in yet other aspects, it is expected that the cooling mechanism will allow for a cooling time of at least 60% less than conventional cooling time.

Without wishing to be bound by theory, it is expected that in some instances, the seal strength could be approximately the same or better as when conventional cooling is used. Because the cooling rate as provided herein can be enhanced, however, the seal strength can reach its desired strength sooner than with conventional cooling. Consequently, overall production times may be quicker and efficiency thereby improved. In addition, with the use of more effective cooling as provided herein, sealing time may also be reduced. For example, the sealing bars can be set at a higher temperature so the seal is formed faster (i.e., a higher temperature difference, dT, and hence a higher heat flow). In this case, the seal will have a higher temperature after opening the bars, but due to the forced cooling the heat flow during cooling also is higher.

Seals provided by the methods and apparatus provided herein are expected to have improved sealing characteristics and aesthetic characteristics (e.g., less wrinkling or crinkling of the package). The seals formed by the apparatus and processes can be measured using ASTM F1921 (2012), method B standards.

The apparatus and methods can be used with various film materials to form packages having desirable characteristics. For example and while not to be construed as limiting, various known plastic material can be used as film 120 to form packages 122.

While cooling mechanisms 112 are shown in FIGS. 2-4 positioned below hot sealing lip 110, cooling mechanisms 112 could alternatively be provided above the hot sealing lip 110 and configured to provide the desired cooling. In still other aspects, cooling mechanisms 112 could be provided above and below hot sealing lip 110 and configured to provide multiple cooling contacts for each side of the film 120 or film 133 and further to provide the desired cooling aspects discussed herein.

Plastic films including multilayer films can be sealed using the apparatus disclosed herein. Referring now to FIG. 4, multilayer film 133 can be sealed and cooled, as discussed hereinabove, to form package 132. Multilayer film 133 can include for example first inner layer 130a and second inner layer 130b as well as first outer layer 131a and second outer layer 131b. Multilayer film 133 can thus be selected from various multilayer films, including but not limited to, a multilayer film having two outer layers 131a, 131b and two inner layers 130a, 130b as shown in FIG. 4.

Exemplary multilayer films include a multilayer film 133 that can have first and second outer layers 131a, 131b; a first inner layer 130a positioned adjacent to the first outer layer; and a second inner layer 130b positioned adjacent to the first inner layer 130a and the second outer layer 131b. In some aspects, the first and second inner layers can include a glass transition temperature (T_{g}) less than or equal to 150° C. and a melt temperature of greater than or equal to 47° C. In some aspects, the first and second inner layer can have very low Tg (e.g., −30° C. to −150° C., and in some cases, −40° C. to −125° C.) and high melt temperatures (e.g., greater than or equal to 120° C., in some cases, greater than or equal to 130° C. and in some cases, 130° to 180° C.). For example and depending on the product to be formed, suitable inner layers may include one or both inner layers being formed of very low Tg/high melt temperature materials. In some cases, PE-LD having a Tg/melt temperature of −125° C./130° C., PVDF having a Tg/melt temperature of about −40° C./171° C., EVA (e.g., having high percent vinyl acetate (VA)) having a Tg/melt temperature of −25/47° C. and combinations thereof could be use herein for one or more of the layers. While EVA has a low melt temperature, EVA can provide desirable sealing properties. In some particular aspects, suitable first and second inner layers, include but are not limited to, at least one of: low density polyethylene (LDPE), polyvinylidene fluoride, ethylene vinyl acetate (EVA) and combinations including at least one of the foregoing. For example and while not to be construed as limiting, at least one of the first and second inner layers in the multilayer film can include low density polyethylene (LDPE) having a glass transition temperature (T_{g}) of −125° C. and a melt temperature of at least 130° C.; at least one of the first and second inner layers can include polyvinylidene fluoride (PVDF) having a glass transition temperature (T_{g}) of −40° C. and a melt temperature of at least 171° C.; at least one of the first and second inner layers can include ethylene vinyl acetate (EVA) having a glass transition temperature (T_{g}) of less than −25° C. and a melt temperature of at least 47° C.; and combinations thereof. The inner layers can have a lower Tg/melt temperature than the outer layers. The inner layer can laminate easily on outer layer to provide optimal sealing properties whereas the outer layer can provide desired properties such as barrier properties and mechanical and/or optical properties. Upon sealing, the first and second outer layers, the first inner layer and the second inner layer forming the sealed multilayer film 133 can be configured to provide a sealed plastic film (e.g. a sealed multilayer film) that includes a hot tack strength of at least 0.1N as determined by ASTM F1921 (2012), method B (based on a 15 mm width strip of film).

While not intended to be limiting, exemplary first inner layer 130a and second inner layer 130b can be selected from at least one of: low density polyethylene (PE-LD or LDPE), LLDPE, vLLDPE (very low linear density polyethylene), plastomer, polyvinylidene fluoride (PVDF), ethylene-vinyl acetate (EVA), ethylene vinyl alcohol (EVOH), polypropylene (PP), polyvinyl chloride (PVC), polyamide (PA), polyethylene terephthalate (PET), polybutylene terephthalate (PBT), polycarbonate (PC), ionomer or inomer combinations of the foregoing and combinations of any of the foregoing.

Exemplary outer layers 131a, 131b can be formed of a material selected from the group including: low density polyethylene (PE-LD or LDPE), high density polyethylene (PE-HD or HDPE), linear low density polyethylene (PE-LLD or LLDPE), polyvinylidene fluoride (PVDF), ethylene-vinyl acetate (EVA), ethylene vinyl alcohol (EVOH), polypropylene (PP), polyvinyl chloride (PVC), polyamide (PA), polyethylene terephthalate (PET), polybutylene terephthalate (PBT), polycarbonate (PC), ionomers of any of the foregoing and combinations of any of the foregoing. The first and second outer layers can be formed from the same or different material.

Details of examples of multilayer film materials shown in FIG. 4 can be found in commonly owned and copending application Ser. No. 62/264,466, Attorney Docket No. (P080164US) and entitled “Multilayer Films Suitable For Use In Form, Fill, And Seal Processes And Packages Formed Thereby” and filed on even date herewith. The entire contents of commonly owned and copending application Ser. No. 62/264,466, Attorney Docket No. (P080164US) are incorporated herein by reference.

As used herein, a “plastic film” includes a single layer film or a multilayer film.

As used herein, “hot tack strength” refers to the peeling force required to separate films when the sealing area is not completely cooled down to ambient conditions. The hot-tack strength is thus the seal force of the plastic film when the seal still is warm, prior to cooling. An exemplary device for measuring hot tack strength is J&B Hot Tack Tester, Model 4000, commercially available from Swiss Management NV. Hot tack is heat seal strength immediately after sealing and before cooling and reaching a maximum seal strength. The seals formed using the disclosed apparatus and methods provided can allow for hot tack strength of at least 0.1N as determined by ASTM F1921 (2012), method B (based on a 15 mm width strip of film).

As used herein, “hot tack force” refers to the peeling force required when sealing area is not completely cooled.

As used herein, a “hot seal” on a plastic film refers to a seal that has been formed from a heating mechanism, but prior to cooling the hot seal. “Hot seal” on a plastic film can thus have a hot tack force of at least 0.1N as determined by ASTM F1921 (2012), method B (based on a 15 mm width strip of film). A “hot sealed plastic film” can thus have a hot tack force of at least 0.1N as determined by ASTM F1921 (2012), method B (based on a 15 mm width strip of film).

As used herein, a “sealed plastic film” includes a plastic film subsequent to cooling. The sealed plastic film can include being sealed at a bottom portion of a package (for example prior to filling of the package). In addition, a sealed plastic film can include a film sealed at both a bottom and a top portion of a package (for example subsequent to filling of the package). A “sealed plastic film” thus can thus have a hot tack strength of at least 0.1N as determined by ASTM F1921 (2012), method B based on a 15 mm width strip of film). A plastic film is intended to include a multilayer film, and a sealed plastic film includes a sealed multilayer film.

Embodiment 1. An apparatus for sealing plastic film materials, includes: a heating mechanism, the heating mechanism including a heating lip arranged such that when a plastic film (e.g., a multilayer film) is contacted with the heating lip, the heating lip forms a hot seal on the plastic film; and a cooling mechanism, the cooling mechanism comprising a gas jet duct oriented to enable a gas jet to contact the hot seal on the plastic film at a contact angle of between 0 and 60° such that the hot seal formed on the plastic film is cooled to a cooled temperature of less than or equal to 40° C. in a period of time of less than or equal to 5 seconds to form a sealed plastic film, (for example wherein the contact angle comprises at least one of a contact angle αₐ and a contact angle α_{b}).

Embodiment 2. The apparatus of claim 1, wherein the cooling mechanism includes a plurality of gas jet ducts.

Embodiment 3. The apparatus of Embodiments 1 or 2, wherein the contact angle is between 15 to 60°.

Embodiment 4. The apparatus of Embodiments 1 or 2, further including a gas jet includes at least one of air jet, nitrogen jet, an inert gas jet.

Embodiment 5. The apparatus of Embodiment 4, wherein the gas jet includes a compressed air jet.

Embodiment 6. The apparatus of Embodiment 5, wherein the contact angle is between 15-60°.

Embodiment 7. The apparatus of any of Embodiments 1-6, wherein the apparatus is arranged such that the plastic film is configured to pass between two die halves, wherein each die half comprises a heating lip.

Embodiment 8. The apparatus of Embodiment 7, wherein the heating mechanism and the cooling mechanism are contained on both sides of the die.

Embodiment 9. The apparatus of Embodiment 7, wherein the apparatus is arranged such that the plastic film is configured to pass between two die halves, and wherein the heating mechanism and the cooling mechanism are contained within one side of a die.

Embodiment 10. The apparatus of any of Embodiments 1-9, wherein the cooling mechanism is operable in a temperature range of 0 to 40° C.

Embodiment 11. The apparatus of any of Embodiments 1-10, wherein the period of time is less than or equal to 4 seconds, preferably, wherein the period of time is less than or equal to 3 seconds.

Embodiment 12. The apparatus of any of Embodiments 1-11, wherein the heating mechanism is operable in a temperature range of 40-350° C.

Embodiment 13. The apparatus of Embodiment 12, wherein the heating mechanism is configured to provide the hot seal to the plastic film at a temperature of 200-300° C., or preferably 40° C. to 160° C.

Embodiment 14. The apparatus of any of Embodiments 1-13, further including a source for the plastic film.

Embodiment 15. The apparatus of any of Embodiments 1-14, further including a back sealing mechanism configured to provide a back seal on the plastic film prior to forming the hot seal on the plastic film such that the hot seal is substantially transverse to the back seal.

Embodiment 16. The apparatus of any of Embodiments 1-20, wherein the apparatus includes a form, fill, and seal (FFS) apparatus.

Embodiment 17. The apparatus of any of Embodiments 1-16, wherein the apparatus is configured to cool and form the sealed plastic film to greater than or equal to 40° C. in at least 40% less time relative to a comparative plastic film formed of the same material and same dimensions and having a hot seal formed from the same hot sealing lip to reach the same ambient temperature, but without the cooling mechanism.

Embodiment 18. The apparatus of any of Embodiments 1-17, wherein the cooled temperature is 20° C.-30° C.

Embodiment 19. A method of forming seal on a plastic film includes: introducing a plastic film to an apparatus including a die, the apparatus including a heating mechanism including a heating lip and a cooling mechanism including a gas jet duct; and forming a hot seal on the plastic film with the sealing lip; withdrawing the sealing lip from the plastic film; and cooling the hot seal with a gas jet to form the sealed plastic film, wherein the hot seal is cooled to a cooled temperature of less than or equal to 40° C. in less than or equal to 5 seconds, to form a sealed plastic film.

Embodiment 20. The method of Embodiment 19, wherein the period of time is less than or equal to 10 seconds, preferably wherein the period of time is less than or equal to 8 seconds.

Embodiment 21. The method of any of Embodiments 19-20, wherein the hot seal is formed at a temperature of 40-350° C.

Embodiment 22. The method of Embodiment 21, wherein the hot seal is formed at a temperature of 200-350° C., or preferably 40° C.-160° C.

Embodiment 23. The method of any of claims 19 -22, further comprising forming a back seal on the plastic film prior to forming the hot seal on the plastic film such that the hot seal is substantially transverse to the back seal.

Embodiment 24. The method of any of Embodiments 19-23, wherein the cooled temperature is less than or equal to 80° C.

Embodiment 25. The method of any of Embodiments 19-24, comprising forming the hot seal and cooling to less than or equal to 40° C. in at least 40% less time relative to a comparative plastic film formed of a same material and having a hot seal formed from the same hot sealing lip to reach the same ambient temperature without the cooling mechanism.

Embodiment 26. The method of any of claims 19-25, comprising forming the hot seal and cooling to less than or equal to 40° C. at least 50% less time relative to a comparative plastic film formed of the same material and having a hot seal formed from the same hot sealing lip to reach the same ambient temperature without the cooling mechanism.

Embodiment 27. The method of any of claims 19-26, sealed plastic film includes a seal strength of at least 0.1N as determined by ASTM F1921 (2012), method B (based on a 15 mm width strip of film).

Embodiment 28. An apparatus for sealing plastic film materials, includes: a heating mechanism, the heating mechanism including a heating lip arranged such that when a plastic film contacted with the heating lip, the heating lip forms a hot seal on the plastic film; and a cooling mechanism, the cooling mechanism including a gas jet duct oriented to provide a gas jet to contact the hot seal on the plastic film at a contact angle between 0-60° such that the hot seal formed on the plastic film is cooled to a cooled temperature of less than or equal to 40° C. in less than or equal to 5 seconds to form a sealed plastic film, wherein the sealed plastic film includes a seal strength of at least 0.1N as determined by ASTM F1921 (2012), method B (based on a 15 mm width strip of film).

Embodiment 29. A method of forming a seal on a plastic film, the method including: introducing a plastic film to an apparatus comprising a die, the apparatus including a heating mechanism including a heating lip and a cooling mechanism including a gas jet; and forming a hot seal on the plastic film with the sealing lip; withdrawing the sealing lip from the plastic film; and cooling the hot seal with a gas jet to form the sealed plastic film, wherein the hot seal is cooled to a temperature of less than or equal to 40° C. in a period of time of less than or equal to 5 seconds, wherein the sealed plastic film comprises a hot tack strength of at least 0.1N as determined by ASTM F1921 (2012), method B (based on a 15 mm width strip of film).

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, for example, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. As used herein, ambient temperature is 20° C. to 40° C.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/we claim:

1. An apparatus for sealing plastic film materials, comprising:
a heating mechanism, the heating mechanism comprising a heating lip arranged such that when a plastic film is contacted with the heating lip, the heating lip forms a hot seal on the plastic film; and
a cooling mechanism, the cooling mechanism comprising a gas jet duct oriented to enable a gas jet to contact the hot seal on the plastic film at a contact angle of between 0 and 60° such that the hot seal formed on the plastic film is cooled to less than or equal to 40° C. in a period of time of less than or equal to 5 seconds to form a sealed plastic film.

2. The apparatus of claim 1, wherein the cooling mechanism comprises a plurality of gas jet ducts.

3. The apparatus of claim 1, wherein the contact angle is between 15-60°.

4. The apparatus of claim 1, further including a gas jet comprising an inert gas jet.

5. The apparatus of claim 1, wherein the gas jet comprises at least one of a compressed air jet, a nitrogen jet.

6. The apparatus of claim 1, wherein the apparatus is arranged such that the plastic film is configured to pass between two die halves, wherein each die half comprises a heating lip.

7. The apparatus of claim 6, wherein the heating mechanism and the cooling mechanism are contained on both sides of the die.

8. The apparatus of claim 6, wherein the apparatus is arranged such that the plastic film is configured to pass between two die halves, and wherein the heating mechanism and the cooling mechanism are contained within only one side of a die.

9. The apparatus of claim 1, further comprising a source for the plastic film.

10. The apparatus of claim 1, further comprising a back sealing mechanism configured to provide a back seal on the plastic film prior to forming the hot seal on the plastic film such that the hot seal is substantially transverse to the back seal.

11. The apparatus of claim 1, wherein the apparatus comprises a form, fill, and seal apparatus.

12. A method of forming a seal on a plastic film, the method comprising:
introducing a plastic film to an apparatus comprising a die, the apparatus comprising a heating mechanism including a heating lip and a cooling mechanism including a gas jet duct; and
forming a hot seal on the plastic film with the sealing lip;
withdrawing the sealing lip from the plastic film; and
cooling the hot seal with a gas jet to form the sealed plastic film, wherein the hot seal is cooled to less than or equal to 40° C. in a period of time of less than or equal to 5 seconds.

13. The method of claim 12, wherein the gas jet has a temperature range of 0-40° C.

14. The method of claim 12, wherein the period of time is less than or equal to 1 to 5 seconds.

15. The method of claim 12, wherein the hot seal is formed at a temperature of 40-350° C.

16. The method of claim 15, wherein the hot seal is formed at a temperature of 200-350° C.

17. The method of claim 12, further comprising forming a back seal on the plastic film prior to forming the hot seal on the plastic film such that the hot seal is substantially transverse to the back seal.

18. The method of claim 12, comprising forming the hot seal and cooling to ambient temperature at least 50% less time relative to a comparative plastic film formed of the same material and having a hot seal formed from the same hot sealing lip to reach the same ambient temperature without the cooling mechanism.

19. A plastic article comprising the hot seal of claim 12.

20. The plastic article of Claim, 19, wherein the article is at least one of a food storage package, a cosmetic storage packages, a soap storage package, and pharmaceutical package.
